(19) United States
(12) Patent Application Publication
(10) Pub. No.: US 2009/0267021 A1
(43) Pub. Date: Oct. 29, 2009

(54) Colloidal silica for semiconductor wafer polishing and production method thereof

(76) Inventors: Masaru Nakajo, Tokyo (JP); Yukiyo Saito, Tokyo (JP); Kunio Ohkubo, Tokyo (JP); Kuniaki Maejima, Tokyo (JP); Hiroaki Tanaka, Ayase-shi (JP)

Correspondence Address: FLYNN THIEL BOUTELL & TANIS, P.C., 2026 RAMBLING ROAD, KALAMAZOO, MI, 49008-1631, US

(21) Appl. No.: 12/384,905

(22) Filed: Apr. 10, 2009

(30) Foreign Application Priority Data
Apr. 24, 2008 (JP) 2008-114065

(51) Int. Cl. C09K 13/00

(52) U.S. Cl. 252/79.1

(57) ABSTRACT

Colloidal silica forming nonspherical particles cluster, whose long axis/short axis ratio of silica particles is of 1.2 to 20, and average long axis/short axis ratio of 3 to 15. This colloidal silica can be produced by forming particles by adding basic nitrogen compounds to an active silicic acid aqueous solution, the solution which produced by hydrolysis of tetraalkoxysilane, while heating, then growing particles by using a build up method.

### FIELD OF THE INVENTION

The present invention relates to colloidal silica for semiconductor wafer polishing that polishes a surface or an edge part of a semiconductor wafer such as a silicon wafer or a semiconductor device substrate with a film such as a metal film, an oxide film, a nitride film or the like (hereinafter shortened to metal films) on the surface, and the production method thereof.

Hereinafter, “colloidal silica for semiconductor wafer polishing” can be shortened to “colloidal silica for polishing”.

### BACKGROUND OF THE INVENTION

Electronic components such as ICs, LSIs or ULSIs which applying semiconductor materials, such as silicon single crystal, as raw material can be manufactured based on a small semiconductor device chips. Said small semiconductor device chips are fabricated by dicing thin disk shaped wafers on which a number of fine electronic circuits are built to semiconductor chips, where the wafers are fabricated by slicing a single crystal ingot of silicon or semiconductors of other compound to thin disk shaped wafers. A wafer sliced from the ingot is processed into a mirror wafer with a mirror finished surface and edge through the processes of lapping, etching, and polishing. In following device manufacturing process, fine electric circuits are formed on the mirror finished surface of the wafer. At present, from the view point of developing high speed LSIs, material for wiring has changed from conventional Al to Cu, which is characterized to have lower electric resistance. Also an insulation film existing between wirings has changed from a silicon oxidation film to a low permittivity film which is characterized to have lower permittivity. Further, for the purpose of protecting the diffusion of Cu into the low permittivity film, a wiring forming process is shifting to a new process which interposing a barrier film made from tantalum or tantalum nitride between Cu and the low permittivity film. According to such a circuit structure formation and a high integration requirement, a polishing process is carried out frequently and repeatedly to planarize the interlayer insulation film, to form a metal plug between upper and lower wirings, to form an embedded wiring or the like. Generally, the polishing step is processed by rotating the semiconductor wafer which is placed on and pressed against a platen on which a polishing cloth made from synthetic resin foam, suede-like synthetic leather or the like is applied, while a quantitative amount of polishing compound solution is supplied so as to polish the semiconductor wafer.

On the edge surface of the wafer, above mentioned metal films or the like are disorderly accumulated. Before dicing the wafer to semiconductor device chips, various wafer transportation processes exist. The wafer is supported at the edge when it is subject to the transportation and the like while keeping an initial disk shape. If outermost periphery edge of the wafer is unevenly structured at the transportation, minute crushes are caused at the edge part of the wafer when the wafer collides with a transporting device and fine particles arose. The fine particles arisen scatter and contaminate the precisely processed wafer surface, and affect seriously on yield and quality of products. To prevent the contamination by the fine particles, the edge part of the semiconductor wafer is required to have a mirror polishing process after the metal films or the other are formed.

Above mentioned edge polishing is performed by a method mentioned below. First, an edge part of a semiconductor wafer is pressed against a polishing machine which has a polishing cloth supporter, on which a polishing cloth made from synthetic resin foam, synthetic leather, nonwoven fabric or the like is applied. Then, the polishing cloth supporter and/or the wafer are rotated while a polishing compound solution which containing polishing particles, such as silica, as a main component is supplied. As the polishing particles to be contained in said polishing compound, one can use colloidal silica which is similar to the one used for edge polishing of a silicon wafer, fumed silica, cerium oxide or alumina that is used for surface polishing of a device wafer, or the like. Especially, colloidal silica and fumed silica claim attention because both silica are fine particles and smooth mirror surface can be easily obtained.

The polishing compound mentioned above is also called as “slurry”, which may be called as such in some cases below.

In general, a polishing compound which containing silica particles as main components is given as a solution that contains alkaline components. The polishing mechanism can be described as a combination of a chemical action by the alkaline components, specifically, chemical corrosion of a surface of silicon oxide films, metal films, and the like by the alkaline components, and a mechanical polishing action by silica particles. More specifically, by the corrosive action by the alkaline components, thin and soft eroded layer is formed on a surface of an object to be polished such as a wafer. Said eroded layer is removed by the mechanical polishing action by fine polishing particles. By repeating said actions, the polishing process is progressed.

Further, device wiring is becoming remarkably finer and more precise year by year. According to “International Technology Roadmap for Semiconductors”, target width of device wiring is 50 nm in 2010 and 35 nm in 2013. Considering finer tendency of width of device wiring, copper or copper alloy has become in use as a wiring material. As a polishing compound to be used for semiconductor polishing, oxidative components of copper or selective etching components other than alkaline components are recommended. Especially, amines claim attention as an agent that seldom over etches a wafer, however, a problem has not been solved. Since over etching of device wiring on the semiconductor wafer surface inhibits an operation of a device, it is a serious problem.

Up to the present, various polishing compounds have been proposed for mirror polishing of semiconductor wafers. In Patent Document 1, a polishing compound prepared by dispersing silica in ethylenediamine or hydrazine is disclosed. According to the document, said polishing compound can polish polysilicon at high speed while it seldom etches a silicon oxide insulation film, and providing an advantage that one can use the insulation film as a stopper. In Patent Document 2, a polishing compound prepared by dispersing polishing particles in an imidazole aqueous solution or a methylimidazole aqueous solution is disclosed. According to the document, said polishing compound forms a copper complex which is water soluble and never produces water insoluble solid matter other then polishing particles. Therefore, said polishing compound can prevent scratches and can also prevent dishing because it controls etching of a copper oxide layer. In Patent Document 3, a polishing compound prepared by adding diethylenediamine or piperidine to colloidal silica is disclosed. Said amines act as a weak base component aiming to form a pH buffer solution. In Patent Document 4, a polishing compound containing amino acid which possessing 2 or more nitrogen atoms in a molecular structure, such as arginine, is disclosed. According to the document, said polishing compound has high polishing rate against a copper film, while has low polishing rate against a compound containing tantalum, and is characterized to have excellent selection ratio.

As disclosed in above mentioned Patent Documents 1 to 4, ethylenediamine, diethylenediamine, imidazole, methylimidazole, piperidine, arginine, and hydrazine are useful agents among basic nitrogen compounds for metal polishing. Regarding morpholine, adequate Patent Document can not be found out. Diethylenediamine is also called as piperazine.

Further, many types of colloidal silica composed of nonspherical silica particles are proposed. In Patent Document 5, a stable silica sol which prepared by dispersing amorphous colloidal silica particles into a liquid solvent is disclosed. Said amorphous colloidal silica particles are elongated shaped silica that have uniformed thickness of 5 to 40 nm by an electron microscope observation and extend only in two dimensional. In Patent Document 6, a silica sol composed of amorphous and elongated colloidal silica particles is disclosed. Said silica sol is prepared by growing metal compounds such as aluminum salt before, in the middle or after an adding process of silica. In Patent Document 7, a colloidal silica composed of cocoon shaped silica particles whose long axis/short axis ratio is in range of 1.4 to 2.2 and which produced by hydrolysis of alkoxysilane is disclosed. In Patent Document 8, a production method of colloidal silica containing nonspherical silica particles by using a hydrolysis solution of alkoxysilane instead of an active silicic acid aqueous solution of water glass method and tetraalkylammonium hydroxide as an alkali agent is disclosed.

In a production process of colloidal silica mentioned in Patent Document 5, there is an adding process of water soluble calcium salt, magnesium salt or mixture of salts, which is contained in a product as impurities. In a production process of colloidal silica mentioned in Patent Document 6, there is an adding process of water soluble aluminum salts, which is contained in a product as impurities. Colloidal silica mentioned in Patent Document 7 is desirable because of its high purity according to the fact that using alkoxysilane as a silica source. However, ammonia and large amount of alcohol are required in a reaction system which arises disadvantages such as difficulty in removal of the components, price, and so on. Similarly, since colloidal silica mentioned in Patent Document 8 also uses alkoxysilane as a silica source, it is also high in purity and is desirable. One can produce said silica particles with nonspherical shape, however, technical investigation about adjustment of particle shape is not sufficient.

Patent Document 1: JPH2-146732 A publication

Patent Document 2: JP2005-129822 A publication

Patent Document 3: JPH11-302635 A publication

Patent Document 4: JP2002-170790 A publication

Patent Document 5: JPH1-317115 A publication (especially in claims)

Patent Document 6: JPH4-187512 A publication

Patent Document 7: JPH11-60232 A publication (especially in claims

Patent Document 8: JP2001-48520 A publication (especially in claims and in Examples)

### DISCLOSURE OF THE INVENTION

The present invention relates to a colloidal silica for mirror polishing of a surface or an edge part of a semiconductor wafer, which prevents over etching of the semiconductor wafer surface while maintaining high polishing rate and providing satisfactory surface roughness, and the production method thereof.

The inventors of the present invention have found that one can polish a surface or an edge part of a semiconductor wafer effectively by using colloidal silica which produced from an active silicic acid aqueous solution obtained by hydrolysis of tetraalkoxysilane and specific basic nitrogen compounds, and accomplished present invention.

The first invention of the present invention is a colloidal silica for semiconductor wafer polishing prepared from an active silicic acid aqueous solution obtained by hydrolysis of tetraalkoxysilane such as tetramethoxysilane or tetraethoxysilane and specific basic nitrogen compounds, wherein said colloidal silica contains nonspherical silica particles. As basic nitrogen compounds, at least one compound selected from the group consisting of ethylenediamine, diethylenediamine, imidazole, methylimidazole, piperidine, morpholine, arginine or hydrazine can be used. Further, it is desirable that quaternary ammonium hydroxide, such as tetramethylammonium hydroxide, tetraethylammonium hydroxide or choline (also known as trimethyl-2-hydroxyethylammonium hydroxide) is contained. Also, it is desirable that the concentration of alkali metal to entire solution of colloidal silica is less than 1 ppm. Furthermore, it is desirable to contain above mentioned components, and has a pH of 8.5 to 11.0 at 25° C. Said colloidal silica is desirable to form a buffer solution by mixing basic nitrogen compounds and strong acid or by mixing weak acid and quaternary ammonium hydroxide, which displays pH buffering action in the pH range of 8.5 to 11.0 at 25° C.

Nonspherical silica particles contained in said colloidal silica for polishing is desirable to be nonspherical silica particles cluster which have long axis/short axis ratio of 1.2 to 20, average long axis/short axis ratio of 3 to 15, and average short axis length of 5 to 30 nm by a transmission electron microscope observation. Said colloidal silica for semiconductor wafer polishing is desirable to be water dispersion whose concentration of silica to entire colloidal solution is of 2 to 50 wt %.

The second invention of the present invention is a production method of colloidal silica for semiconductor polishing comprising:

(a) a producing process of an active silicic acid aqueous solution by hydrolysis of tetraalkoxysilane with acid catalyst in a composition of 1 to 8 mol/L tetrametoxysilane, 0.0018 to 0.18 mol/L acid, and 2 to 30 mol/L water without using organic solvent, diluting with water so as to adjust the concentration within range of 0.2 to 1.5 mol/L; and

(b-1) a formation process of colloidal particles by heating said active silicic acid aqueous solution after alkalizing the solution by adding said basic nitrogen compounds; and

(b-2) a growing process of colloidal particles by adding said active silicic acid aqueous solution and an alkalizing agent or said active silicic acid aqueous solution, said basic nitrogen compounds, and the alkalizing agent to colloidal particles formed in the process (b-1) while maintaining in alkaline condition under heating condition.

Having a process (c) a concentration process of the colloidal silica after the process (b-2) is desirable.

### EFFECT OF THE INVENTION

By using a colloidal silica for polishing of the present invention, one can obtain excellent effect in preventing over etching in polishing of a semiconductor wafer and the like. “Over etching” is a phenomenon that causes by corrosion of a wiring metal which results formation of recesses during polishing process of the wiring metal, an insulation film or a barrier film. Over etching occurs when a balance of corrosive speed between a mechanical polishing action by polishing particles and a corrosive action by alkaline component is broken. Over etching is recognized as a ground of defective products such as corrosive pits, wiring corrosions or key holes of tungsten wiring. Further, since said colloidal silica does not contain alkali metals, problems such as remaining of polishing particles or dispersion of alkali metal to wiring layer can be prevented. By the present invention, the colloidal silica for polishing with excellent polishing ability and continuance ability for mirror polishing which improve the flatness of the surface of the polished wafer can be obtained, and the present invention has great influence to the relating field.

### BRIEF ILLUSTRATION OF DRAWINGS

FIG. 1: TEM picture of colloidal silica obtained in Example 1.

FIG. 2: TEM picture of colloidal silica obtained in Example 2.

FIG. 3: TEM picture of colloidal silica obtained in Example 5.

FIG. 4: TEM picture of colloidal silica obtained in Example 6.

### DESCRIPTION OF PREFERRED EMBODIMENT

As mentioned above, basic nitrogen compounds are the useful agents in metal polishing and are disclosed in many Patent Documents. In the meanwhile, a technique to obtain nonspherical silica particles using an active silicic acid aqueous solution obtained by hydrolysis of tetraalkoxysilane is disclosed in Patent Document 8 and is the public known technique. However, a technique to obtain nonspherical silica particles by hydrolysis of tetraalkoxysilane using specific basic nitrogen compounds, such as ethylenediamine, diethylenediamine, imidazole, methylimidazole, piperidine, morpholine, arginine or hydrazine, is the first clarified technique by the present invention.

Ethylenediamine is a strong base whose logarithms of reciprocal number of acid dissociation constant (pKa) is about 9.9 and a pH of a 1% aqueous solution is about 11.8. There are two sorts of ethylenediamine: ethylenediamine anhydride and ethylenediamine mono hydrate. Ethylenediamine mono hydrate is preferred because it is less dangerous agent. Another name of diethylenediamine is piperazine and is also known as hexahydropyrazine or diethyleneimine. There are two sorts of diethylenediamine: diethylenediamine anhydride and diethylenediamine hexahydrate. Diethylenediamine hexahydrate is easier to use. Diethylenediamine is a strong base whose pKa is about 9.8 and a pH of a 1% aqueous solution is about 11.5. Imidazole is a weak base whose pKa is about 6.9 and a pH of a 1% aqueous solution is about 10.2. 2-methylimidazole is a weak base whose pKa is about 7.8 and a pH of a 1% aqueous solution is about 10.7. 4-methylimidazole can also be used instead of 2-methylimidazole. Other names of piperidine are hexahydropyridine and pentamethyleneimine. Piperidine is a strong alkali whose pKa is about 11.1 and a pH of a 1% aqueous solution is about 12.3. Morpholine is a slightly weak base whose pKa is about 8.4 and a pH of a 1% aqueous solution is about 10.8. Arginine is one of amino acids which also known as 5-guadidino-2-amino pentanoic acid and is a base whose pKa is about 12.5 and a pH of a 1% aqueous solution is about 10.5 because it possesses a carboxy group. Although each of D-, L- or DL-arginine can be used, L-arginine is preferably used among three because of low price. There are two sorts of hydrazine: hydrazine anhydrous and hydrazine monohydrate (also known as hydrohydrazine or hydrazine hydrate). Hydrazine monohydrate is preferred because it is less dangerous agent. Hydrazine is a strong reducing agent, however, as a base, it is a weak base whose pKa is about 8.1 and a pH of a 1% aqueous solution is about 9.9.

It is desirable that any kind of above mentioned basic nitrogen compounds do not contain alkali metals. Since any kind of said basic nitrogen compounds except arginine has strong irritative feature, toxicity, and corrosive feature, it is desirable to be used as an aqueous solution of about 10% concentration.

Above mentioned basic nitrogen compounds act as a polymerization catalyst of silica of an active silicic acid aqueous solution due to its basic feature. That is, colloidal particles can be obtained by heating the active silicic acid aqueous solution after alkalizing the solution by adding said basic nitrogen compounds. In the meanwhile said basic nitrogen compounds affect particle form at a growing process of colloidal particles. Said basic nitrogen compounds bond with or adsorbs to surfaces of silica particles in the growing process and inhibits growing of particles at bonded parts and disturbs spherical growing of particles.

In the present invention, for the purpose of maintaining a stable polishing ability at actual polishing processes, it is desirable to maintain a solution at a pH of 8.5 to 12.5 at 25° C. When the pH is lower than 8.5, polishing speed becomes slow and is out of practical use. Further, when the pH is higher than 11.0, the solution over etches nonpolishing parts of a wafer and deteriorates a flatness of the wafer and is again out of practical use.

Further, it is desirable that a pH of the solution does not change easily by exterior conditions such as abrasion, heating, contacting with outer atmosphere, mixing with other components or the like. Especially, in a case of edge polishing, a polishing compound is used by a circulation flow. That is, the polishing compound supplied from a slurry tank to polishing parts sent back to the slurry tank so that to be reused. In a case of a polishing compound that contains an alkalizing agent alone, a pH of the solution falls in short time since the solution is diluted with pure water used in the circulation flow. The phenomenon is caused by influx of pure water, which is used as cleaning water. Alternation of the pH affects a polishing rate, and lack of polishing or over polishing is easily caused.

For the purpose of maintaining a pH of colloidal silica for polishing of the present invention, it is desirable that colloidal silica has a buffer function in a pH range of 8.5 to 11.0. Therefore, in the present invention, it is desirable to make colloidal silica for polishing itself a strong buffer solution that does not change a pH dramatically according to exterior conditions. To form a buffer solution, a method of blending basic nitrogen compounds in excess, followed by neutralization of the excess part by adding strong acid to adjust pH value close to pKa value of the basic nitrogen compounds can be mentioned. For example, when a pH of a solution is adjusted to 10.2 by adding hydrochloric acid to 1% diethylenediamine aqueous solution whose pH is about 11.5, the pH of the solution becomes stable against dilution or mixing with salts. That is, even if the solution has done the 1 to 10 dilution with pure water, the pH only changes to 10.1, resulting pH does not change dramatically by dilution or mixing with salts. Accordingly, it is possible to adjust a pH at higher value compare to an aimed value and reduce the pH to the aimed value by adding strong acid. Further, as another method, a method of adding a buffer solution prepared by mixing weak acid and strong base can be mentioned. For example, a method of neutralizing a 25% tetramethylammonium hydroxide aqueous solution with carbon dioxide gas to adjust a pH of 10.3, followed by addition of said carbonated tetramethylammonium hydroxide aqueous solution to colloidal silica can be mentioned.

As a production method of an active silicic acid aqueous solution to be used in the present invention, a method disclosed in Patent Document 8 can be used. That is, the production method of an active silicic acid aqueous solution by hydrolysis of tetraalkoxysilane with acid catalyst in a composition of 1 to 8 mol/L tetrametoxysilane, 0.0018 to 0.18 mol/L acid, and 2 to 30 mol/L water without using solvent, then diluting with water so as to adjust the silica concentration within range of 0.2 to 1.5 mol/L.

A production method of colloidal silica of the present invention can be illustrated as follows. First, an active silicic acid aqueous solution is produced as mentioned above. Said basic nitrogen compounds are added to the said active silicic acid aqueous solution so as to alkalize the solution. Then, colloidal particles are formed by heating the solution (a seed particles forming process, process (b-1) of claim 9). Next, above mentioned active silicic acid aqueous solution and an alkalizing agent or above mentioned active silicic acid aqueous solution, the basic nitrogen compounds, and the alkalizing agent are added to the colloidal solution formed in the previous process while maintaining in alkaline condition under heating condition to grow colloidal solution (a particles growing process, process (b-2) of claim 9). At the seed particles forming process, the basic nitrogen compounds are used together with the alkalizing agent, however, at the particles growing process, use of the alkalizing agent alone is possible.

Specifically, in above mentioned seed particles forming process and particles growing process, conventional operations are used. For example, seed particles whose short axis length (thickness) is of 5 to 20 nm can be formed as follows. First, silica concentration of an active silicic acid aqueous solution is set to 2 to 7 wt %. By adding basic nitrogen compounds, a pH of the solution is adjusted to 8 to 11. The solution is heated to the temperature of 60 to 240° C. to obtain said seed particles. Said seed particles can be grown to silica particles whose short axis length (thickness) is of 10 to 150 nm using a build up method. That is, the method of adding an active silicic acid aqueous solution and an alkalizing agent or the active silicic acid aqueous solution, basic nitrogen compounds, and the alkalizing agent to the colloidal solution of said seed particles whose pH is of 8 to 11 and temperature is of 60 to 240° C. The process is carried out while maintaining the solution at the pH of 8 to 11.

Above mentioned production method is almost same as a conventional production method that uses alkali metal hydroxide or alkali silicate as an alkalizing agent. However, at a point that using an active silicic acid aqueous solution obtained by hydrolysis of tetraalkoxysilane instead of an active silicic acid aqueous solution made from sodium silicate, at a point that using basic nitrogen compounds instead of alkali metal hydroxide in a seed particles forming process, and at a point that using an organic alkalizing agent or the basic nitrogen compounds and the organic alkalizing agent instead of alkali metal hydroxide in particles growing process, the production method of the present invention is different from the conventional production method.

As the alkalizing compound used in the particles growing process, quaternary ammonium hydroxide is desirably used, in particular, tetramethylammonium hydroxide, tetraethylammonium hydroxide or choline hydroxide are more desirable. Said organic alkalizing agent is preferred not to contain alkali metals.

As a tetraalkoxysilane used in the present invention, tetramethoxysilane, tetraethoxysilane or the like can be mentioned, however, silicic acid oligomer whose degree of polymerization of 2 to 10 and which is on the market (for example, “Ethylsilicate 40”, product of Colcoat Co., Ltd.) can also be used. In a case of using tetraalkoxysilane, use of a high purified product is desirable.

As the next process, concentration of silica by ultra-filtration is carried out. Concentration by water evaporation can also be used, however, ultra-filtration is more advantageous from the view point of energy consumption.

An ultra-filtration membrane to be used at the concentration process of silica by ultra-filtration can be illustrated as follows. Separation which uses the ultra-filtration membrane is objecting particles with size of 1 nm to several microns. Since dissolved polymer product is also being objected, filtration accuracy is indicated by molecular cutoff in nano-meter region. In the present invention, an ultra-filtration membrane whose molecular cutoff value is smaller than 15000 is desirably used. By using the ultra-filtration membrane of said range, particles larger than 1 nm can be separated. More desirably, an ultra-filtration membrane whose molecular cutoff value is 3000 to 15000 is used. When ultra-filtration membrane whose molecular cutoff value is smaller than 3000 is used, filtration resistance becomes too high and disadvantageous from economical view point, and when molecular cutoff value is over 15000, purification accuracy is deteriorated. As a material of a membrane, polysulfone, polyacrylonitrile, sintered metal, ceramics, carbon or the like can be used, however, from the view point of heat resistance and filtration speed, a membrane made from polysulfone is preferable and easier to use. As a shape of the membrane, any kinds of shapes, such as spiral shape, tubeler shape, hollow filament shape or the like can be used. However, among said shapes, hollow filament shape is preferable because it is compact and easier to use. Further, when the ultra-filtration process acts concurrently as washing and removing process of excess basic nitrogen compounds, it is possible to improve removing rate by adding pure water even after reaching the aimed concentration. Furthermore, it is also desirable to remove strong acid anion which added as a catalyst of hydrolysis. It is desirable to concentrate silica so as the concentration of silica to be of 10 to 50 wt %.

Further, before or after an ultra-filtration process, a purification process by ion-exchange resin can be added if necessary. For example, above mentioned strong acid anion can be removed by contacting with OH type strong basic anion-exchange resin.

Basic nitrogen compounds dissolved in water phase diminish together with water at concentration process by ultra-filtration. When the amount of basic nitrogen compounds became too small, it is desirable to supply the compound after concentration process.

However, existence of an organic compound may cause secondary problem in a liquid-waste treatment process. Considering such a case, a product from which basic nitrogen compounds is removed is also required. A method of reducing the amount of the basic nitrogen compounds as possible by using ultra-filtration effectively is involved in the present invention as one of the production method.

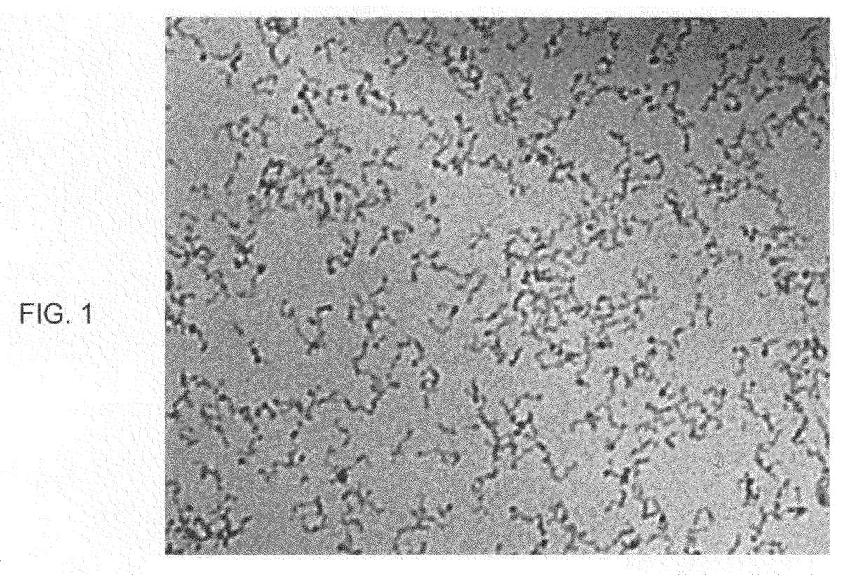

Colloidal silica forming nonspherical particles cluster is characterized to have a shape similar to a caterpillar or a bended rod. Each particle has a different shape, and specifically, said colloidal silica contains silica particles having a shape shown in FIGS. 1 to 4. Long axis/short axis ratio of the colloidal silica is within the range of 1.2 to 20. The most part of the particles are not extended straightly, and nonextended particles are partially existed. Only a few silica particles are shown in FIGS. 1 to 4 as examples, although shapes are changeable by producing conditions, nonspherical shaped ones are major.

Average long axis/short axis ratio of silica particles of the colloidal silica for polishing of the present invention is within the range of 3 to 15 which is suited as polishing particles. If the ratio is larger than 15, the particles intertwine with each other, and if the ratio is smaller than 3, the polishing speed drops.

In a polishing process, a shape of silica particles is a very important factor. That is, by a corrosive action of alkaline, a thin eroded layer is formed on a surface of an object to be polished, and removal rate of the thin layer is changed largely by the shape of particles. When the size of silica particles becomes larger, the removal rate increases. However, scratches are formed easily on the polished surface. Also, nonspherical particles promises larger removal rate compare to spherical shaped particles, however, scratches are formed easily on the polished surface. Therefore, it is desirable that the particles have an adequate size and shape, and the particles must not be crushed easily or agglomerate to form gel.

A shape of the silica particles of the colloidal silica for polishing of the present invention is very similar to the shape of fumed silica. Silica particles of fumed silica generally form nonspherical elongated particles cluster whose long axis/short axis ratio is of 5 to 15. Primary particle size of fumed silica (can be simply described as particle size) indicates short axis length (thickness) and is normally 7 to 40 nm. Further, these particles agglomerate and form secondary particles and appearance of slurry is white. Therefore, when the slurry of fumed silica is preserved for long time, particles tend to precipitate and cause scratches on the polished surface.

On the contrary, although silica particles of the present invention have similar shape to primary particles of fumed silica, silica particles do not form secondary particles by agglomeration, and appearance of slurry is transparent or semi-transparent. Particles do not have tendency to precipitate and do not cause scratches on the polished surface.

Desirable average short axis length of silica particles of the colloidal silica for polishing composed of silica particles of the present invention is of 5 to 30 nm by an electric micrometer observation, and concentration of silica particles is of 2 to 50 wt %. When average short axis length of silica particles is smaller than 5 nm, polishing rate is low and stability of colloid is lacked because particles easily agglomerate. Further, when average short axis length is larger than 30 nm, scratches are easily caused and flatness of the polished surface deteriorates.

The present invention can provide a polishing compound that containing above mentioned colloidal silica for polishing and further, components that can further improve polishing ability are added.

In the present invention, polishing rate can be remarkably improved by elevating the electric conductivity value of the polishing compound solution. Electric conductivity is an index value of conduction of electricity, and indicated by a reciprocal number of electric resistance per unit length. In the present invention, electric conductivity is indicated as converted number of electric conductivity (milli Siemens) to 1 wt % of silica. In. the present invention, when electric conductivity at 25° C. is larger than 15 mS/m/1%-SiO₂, it is desirable to improve the polishing rate and larger than 20 mS/m/1%-SiO₂ is more desirable. Since addition of salts deteriorates stability of colloid, upper limit for amount of salts addition does exist. Upper limit is changeable according to particle size of silica, however, is approximately 60 ms/m/1%- SiO₂.

As a method to elevate an electric conductivity, following two methods can be mentioned. One is to elevate concentration of a buffer solution and another is to add salts. To elevate concentration of the buffer solution, one can elevate only concentration of basic nitrogen compounds and strong acid without changing a molar ratio. Or, one can elevate only concentration of weak acid and quaternary ammonium hydroxide without changing a molar ratio. Salts used for the method of adding salts are composed of acid and base mixture, and as an acid, both strong and weak acid can be used. Mineral acid, organic acid or mixture of these acids can also be used. As a base, use of water soluble quaternary ammonium hydroxide is desirable, because it is not desirable to increase the amount of alkali metal hydroxide.

As a salt composed by strong acid and quaternary ammonium base, it is desirable to use at least one of the compounds selected from the group consisting of quaternary ammonium sulfate, quaternary ammonium nitrate, and quaternary ammonium fluoride. As a cationic ion composing quaternary ammonium strong base, choline ion, tetramethylammonium ion or tetraethylammonium ion are desirable.

A polishing compound containing colloidal silica for polishing of the present invention is desirable to contain a chelating agent that forms a water insoluble chelate compound with copper. For example, as said chelating agent, public known compounds like azoles, such as benzotriazole, or quinoline derivatives, such as quinolinol or quinaldine acid, are desirably used.

For the purpose of improving the feature of said colloidal silica for polishing, surfactant, a water soluble polymer compound or a deforming agent can be used together with.

As a surfactant, nonionic surfactant is desirably used. Nonionic surfactant has a function to protect excess etching. For example, polyoxyalkylenealkylether, such as polyoxyethylenelaurylether, fatty acid ester, such as glycerinester, or polyoxyalkylenealkylamine, such as di(polyoxyethylene)laurylamine, can be used. Preferable concentration of nonionic surfactant contained in a polishing compound containing colloidal silica for polishing is of 0.001 to 0.1 wt %.

As a water soluble polymer compound, at least one of the compounds selected from the group consisting of hydroxyethyl cellulose, polyethylene glycol or polyvinylalcohol is desirable. These compounds have a protecting effect for excess etching. Ethyleneoxide-propyleneoxideblock copolymer is also desirably used. For example, when hydroxyethyl cellulose is used, it acts as a water soluble polymer in the concentration range of 30 to 300 ppm when it is added to the 1 to 100 diluted polishing compound. Therefore, required concentration of hydroxyethyl cellulose in an original polishing compound is of 0.3 to 3 wt %. In the same way, in a case of polyethyleneglycol, required concentration is of 0.3 to 5 wt %, and in a case of polyvinylalcohol, required concentration is of 0.1 to 5 wt %.

As a defoaming agent, silicone emulsion is desirably used. As silicone emulsion, silicone defoaming agent being on the market, which is O/W type emulsion of silicone oil mainly composed of polydimethylsiloxane can be used. Concentration of defoaming agent in polishing compound is of 0.01 to 0.1 wt %.

A polishing compound containing colloidal silica for polishing of the present invention is said as an aqueous solution, however, an organic solvent can be added. Other abrasives, such as colloidal alumina, colloidal ceria or colloidal zirconia, bases, additives or water can be mixed with said polishing compound of the previous invention during a producing process.

Regarding the polishing compound containing colloidal silica for polishing of the present invention, it is desirable to produce with silica concentration of 20 to 50 wt %, and dilution is carried out with pure water at actual use. A pH adjusting agent or salts for adjusting an electric conductivity is added if it is required.

### EXAMPLES

The present invention will be illustrated in more detail in examples. In examples, following equipments are used.

(1) TEM observation: Transmission Electron Microscope H-7500 of Hitachi Ltd., is used.

(2) Specific surface area by BET method: Flow Sorb 2300 of Shimadzu Corporation is used.

(3) Analysis of basic nitrogen compounds except hydrazine: Total organic carbon meter TOC-5000A, SSM-5000A of Shimadzu Corporation is used. Carbon amount is converted into basic nitrogen compounds. Specifically, total organic carbon amount (TOC) is calculated by numerical formula of TOC=TC-IC after total carbon amount (TC) and inorganic carbon amount (IC) are measured. As a standard for TC measurement, a glucose aqueous solution of 1 wt % carbon amount is used, and as a standard for IC measurement, sodium carbonate of 1 wt % carbon amount is used. Ultrapure water is used as a standard of 0 wt % carbon amount. By using above mentioned standards, calculation curves of 150 μL and 300 μL for TC and of 250 μL for IC are prepared. At TC measurement, 100 mg of specimen is picked and burned in a combustion furnace of 900° C. And at IC measurement, 20 mg of specimen is picked, and about 10 mL of (1+1) phosphoric acid are added. The reaction is accelerated in a combustion furnace of 200° C.

(4) Analysis of hydrazine: Absorptiometer UV-VISIBLE RECORDING SPECTRO PHOTOMETER UV-160 of Shimadzu Corporation is used. Measurement is carried out according to p-dimethylbenzaldehyde absorption method regulated in JIS B8224. Specifically, specimen is acidized by hydrochloric acid, followed by addition of p-dimethylbenzaldehyde, to obtain a yellowish compound. Absorbancy of the yellowish compound is measured and hydrazinium ion is quantitated. From the obtained value of hydrazinium ion, concentration of hydrazine is calculated.

(5) Analysis of tetramethylammonium hydroxide (TMAOH): Ion Chromate ICS-1500 of Dionex Corporation is used. Specifically, in cases of liquid phase TMAOH, specimen is diluted 1000 to 5000 times with pure water and measured. Further, in cases of total TMAOH, as a previous treatment, 3 g of 20 wt % NaOH and pure water are added to 5 g of specimen, heated to 80° C. and silica is perfectly dissolved. Obtained dissolved solution is diluted 1000 to 5000 times with pure water and total TMAOH amount is measured.

(6) Analysis of metal elements: ICP emission spectrometry ULTIMA 2 of Horiba, Ltd. is used.

### Example 1

Hydrolysis of tetrametoxysilane is practiced by a composition of 4.49 mol/L tetrametoxysilane, 0.01 mol/L acid, and 18.38 mol/L water without using solvent. Practically, hydrolysis is performed by processes mentioned below.

Diluted hydrochloric acid solution is prepared by adding 0.2 g of 35% hydrochloric acid into 46 g of deionized water. 96 g of tetrametoxysilane (special grade reagent, converted SiO₂ concentration is 39 wt %) is placed into a container, then above mentioned diluted hydrochloric acid solution is added with stirring. At the first stage, said two solutions are separated and are not mixed well. After several minutes, hydrolysis reaction starts with heat evolution, and the mixture becomes transparent homogeneous solution. Stirring is continued another 30 minutes so as the hydrolysis reaction to be completed, and hydrolyzed solution is obtained. Then said solution is diluted by adding 116 g of deionized water to prevent the polymerization of active silicic acid. 742 g of deionized water is poured into another container. The above mentioned hydrolyzed solution is added and total amount is brought up to 1000 g. The solution is matured by stirring for 16 hours. Thus, an active silicic acid aqueous solution having SiO₂ concentration of 3.7 wt % (approximately 0.6 mol/L) and a pH of 2.6 is obtained.

An aqueous solution of basic nitrogen compounds is prepared by a method mentioned below. Ethylenediamine anhydride is dissolved in deionized water and a 10 wt % aqueous solution is prepared. Crystal of diethylenediamine(piperazine)-6- hydrate is dissolved in deionized water and a 8 wt % aqueous solution is prepared. Crystal of imidazole is dissolved in deionized water and a 10 wt % aqueous solution is prepared. Crystal of 2-methylimidazole is dissolved in deionized water and a 10 wt % aqueous solution is prepared. A piperidine solution is diluted with deionized water and a 10 wt % aqueous solution is prepared. A morpholine solution is diluted with deionized water and a 10 wt % aqueous solution is prepared. Crystal of L(+)-arginine is dissolved in deionized water and a 10 wt % aqueous solution is prepared. A hydrazine 1-hydrate solution is diluted with deionized water and a 5 wt % aqueous solution is prepared. Reagents are used for all of above mentioned basic nitrogen compounds.

As quaternary ammonium hydroxide, a 25% tetramethylammonium hydroxide aqueous solution on the market and a 35% tetraethylammonium hydroxide aqueous solution on the market are used without dilution.

An aqueous solution of basic nitrogen compounds prepared as above are added by the amount mentioned in Table 1 to 50 g of an active silicic acid aqueous solution whose silica concentration is 3.7 wt % and a pH is 2.6 at 25° C. Measured pH values are summarized in Table 1. After that, solutions are heated with stirring, and maintained at 100° C. for 1 hour to form colloid particles. Solutions are cooled down to 25° C. and a pH is measured. Measured pH values are summarized in Table 1. According to the observation by a transmission electron microscope (TEM), shapes of any kinds of obtained colloidal silica are similar regardless of kind of basic nitrogen compounds, and colloidal particles form irregularly connected nonspherical particles cluster characterizing that short axis length of about 6 to 7 nm, long axis/short axis ratio of 5 to 20, and average long axis/short axis ratio of 10 to 15. As a typical example, TEM picture of colloidal silica prepared using diethylenediamine is shown in FIG. 1.

TABLE 1

| | | | colloidal silica | |
|---|---|---|---|---|
| | added | pH | | average |
| | amount | after | | short |
| basic nitrogen compound | (g) | added | pH | axis (nm) |
| 10% ethylenediamine | 1.6 | 8.5 | 10.0 | 7-30 |
| 8% diethylenediamine | 3.0 | 8.5 | 9.8 | ≈7 |
| 10% imidazole and | 4.5 and | 9.0 | 9.5 | ≈7 |
| 35% tetraethylammonium hydroxide | 1.0 | | | |
| 10% methylimidazole | 6.7 | 8.7 | 9.2 | ≈5 |
| 10% piperidine | 2.0 | 8.2 | 8.9 | ≈5 |
| 10% morpholine | 7.0 | 8.9 | 9.7 | 7-10 |
| 10% arginine | 5.0 | 8.3 | 9.5 | ≈7 |
| 5% hydrazine | 4.0 | 7.9 | 8.7 | ≈5 |

### Example 2

By same method as Example 1, tetramethoxysilane is hydrolyzed and an active silicic acid aqueous solution having SiO₂ concentration of 3.7 wt % and a pH of 2.6 is obtained. The pH is adjusted to 9.8 by adding 64 g of a 10% morpholine aqueous solution to 500 g of the active silicic acid aqueous solution with stirring. After that, solutions are heated with stirring, maintained at 100° C. for 1 hour, to form colloid particles. Then, while maintaining the temperature at 100° C., 2600 g of the active silicic acid aqueous solution and 40 g of the 10% morpholine aqueous solution are simultaneously added by 4 hours to grow silica particles. After adding process, the solution is matured by maintaining the temperature at 100° C. for 1 hour, then cooled down.

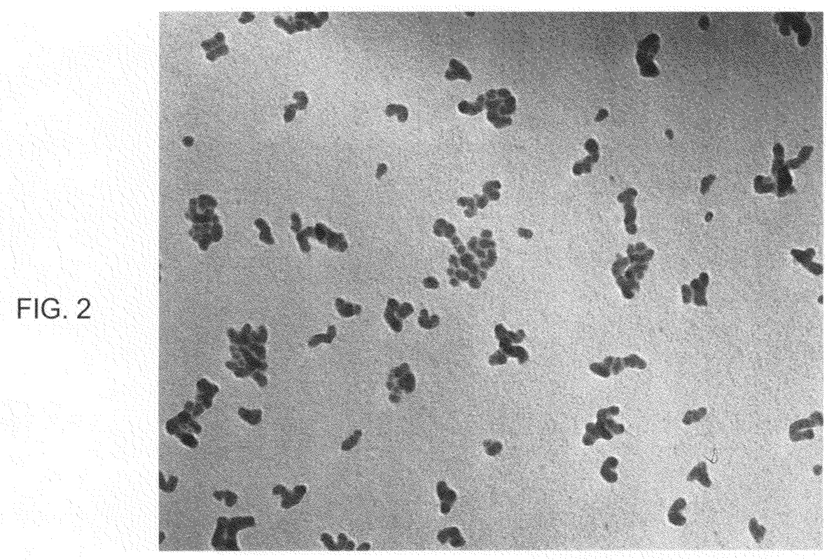

Silica concentration of obtained colloidal silica becomes 5.6 wt % due to evaporation of water and a pH at 25° C is 9.0. According to a transmission electron microscope (TEM) observation, obtained colloidal silica is composed of colloidal particles forming irregularly connected nonspherical particles cluster characterized that short axis length of about 18 nm, long axis/short axis ratio of 1.2 to 7, and average long axis/short axis ratio of 3. TEM picture is shown in FIG. 2. Particle size calculated from BET method specific surface area is 16 nm.

### Example 3

Colloidal silica obtained by Example 2 is concentrated. After that, pressure filtration by pump circulation is carried out using hollow fiber ultra-filter membrane whose molecular cutoff value is 6000 (MICROZA UF MODULE SIP-1013, product of ASAHI KASEI Corp.). In this way, colloidal silica is concentrated to make the solution having SiO₂ concentration of 22.1 wt % and approximately 520 g of concentrated colloidal silica is obtained. Obtained colloidal silica has a pH of 8.6 at 25° C., and alkali metal concentration is smaller than 1 ppm.

### Example 4

100 g of colloidal silica obtained in Example 3 is placed into a container. To this colloidal silica, 10 g of a 10% morpholine aqueous solution is added and a pH of 9.5 is measured. Then the pH is adjusted to 9.0 by adding 5 g of 2.0 wt % hydrochloric acid. When said colloidal silica is diluted 10 times with deionized water, the pH is measured as 9.1 and when said colloidal silica is diluted 100 times, the pH is measured as 9.2. That is, by mixing morpholine and hydrochloric acid, pH buffer solution against dilution is formed.

### Example 5

Hydrolysis of tetrametoxysilane is practiced by composition of 3.38 mol/L tetrametoxysilane, 0.01 mol/L acid, and 13.81 mol/L water without using solvent. Practically, hydrolysis is performed by processes mentioned below.

A diluted hydrochloric acid solution is prepared by adding 1 g of 35% hydrochloric acid into 100 g of deionized water. 96 g of tetraetoxysilane (special grade reagent, converted SiO₂ concentration is 29 wt %) is placed into a container, then above mentioned diluted hydrochloric acid solution is added with stirring. At the first stage, said two solutions are separated and are not mixed well. After several minutes, hydrolysis reaction starts with heat evolution, and the mixture becomes transparent homogeneous solution. Stirring is continued another 30 minutes so as the hydrolysis reaction to be completed, and hydrolyzed solution is obtained. Then said solution is diluted by adding 100 g of deionized water to prevent the polymerization of active silicic acid. 590 g of deionized water is poured into another container. The above mentioned hydrolyzed solution is added and total amount is brought up to 835 g. The solution is matured by stirring for 16 hours. Thus, an active silicic acid aqueous solution having SiO₂ concentration of 3.7 wt % (approximately 0.6 mol/L) and a pH of 2.5 is obtained.

By same method as Example 1, a 8 wt % diethylenediamine aqueous solution, a 10 wt % piperidine aqueous solution, a 10 wt % morpholine aqueous solution, a 10 wt % arginine aqueous solution and a 10 wt % hydrazine aqueous solution are prepared.

As quaternary ammonium hydroxide, a 25% tetramethylammonium hydroxide aqueous solution on the market and a 35% tetraethylammonium hydroxide aqueous solution on the market. are used without dilution.

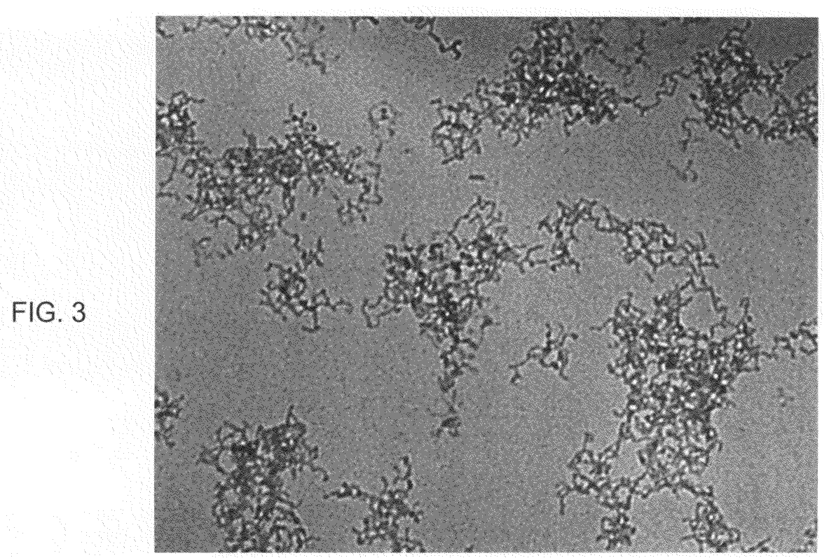

An aqueous solution of basic nitrogen compounds prepared as above are added by the amount mentioned in Table 2 to 250 g of aqueous solution of active silicic acid whose silica concentration is 3.7 wt % and a pH is 2.5, then pH is measured at 25° C. Measured pH values are summarized in Table 2. After that, solutions are heated with stirring and maintained at 100° C. for 1 hour to form colloid particles. Solutions are cooled down to 25° C. and a pH is measured. Measured pH values are summarized in Table 2. According to the observation by a transmission electron microscope (TEM), shapes of all kinds of obtained colloidal silica are similar regardless of kind of basic nitrogen compounds. Obtained colloidal particles form irregularly connected nonspherical particles cluster characterizing that short axis length of about 5 to 7 nm, long axis/short axis ratio of 5 to 20, and average long axis/short axis ratio of 10 to 15. As a typical example, TEM picture of colloidal silica prepared using morpholine is shown in FIG. 3.

TABLE 2

| | | | colloidal silica | |
|---|---|---|---|---|
| | added | pH | | average |
| | amount | after | | short |
| basic nitrogen compound | (g) | added | pH | axis (nm) |
| 8% diethylenediamine | 15.4 | 8.6 | 9.8 | 5.5 |
| 10% piperidine | 10.4 | 8.6 | 8.9 | ≈5 |
| 10% morpholine | 18.2 | 8.6 | 9.1 | 4.8 |
| 10% arginine | 21.3 | 8.6 | 9.5 | 5.4 |
| 10% hydrazine | 10.5 | 8.5 | 9.0 | 5.3 |

### Example 6

By same method as Example 5, tetraethoxysilane is hydrolyzed and an active silicic acid aqueous solution having SiO₂ concentration of 3.7 wt % and a pH of 2.5 is obtained. And, a 2.5 wt % morpholine aqueous solution is also prepared by diluting a 10 wt % solution. The pH is adjusted to 8.6 by adding 18 g of the 10% morpholine aqueous solution to 250 g of the active silicic acid aqueous solution with stirring. After that, solutions is heated with stirring and maintained at 100° C. for 1 hour to form colloid particles. Then, while maintaining the temperature at 100° C., 1600 g of the active silicic acid aqueous solution and 420 g of 2.5 wt % morpholine aqueous solution are simultaneously added by 4 hours to grow silica particles. After adding process, the solution is matured by maintaining the temperature at 100° C. for 1 hour, then cooled down.

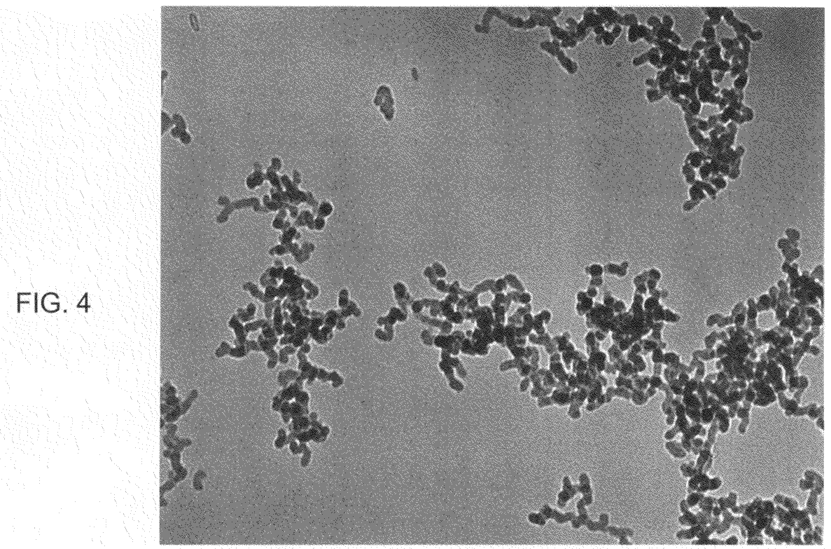

The pH of obtained colloidal silica is 9.7 at 25° C. According to a transmission electron microscope (TEM) observation, obtained colloidal silica is composed of colloidal particles forming irregularly connected nonspherical particles cluster characterized that short axis length of about 18 nm, long axis/short axis ratio of 1.2 to 7, and average long axis/short axis ratio of 3. TEM picture is shown in FIG. 4. Particle size calculated from BET method specific surface area is 13 nm.

### Example 7

Colloidal silica obtained in Example 7 is concentrated. Pressure filtration by pump circulation is carried out using hollow fiber ultra-filter membrane whose molecular cutoff value is 6000 (MICROZA UF MODULE SIP-1013, product of ASAHI KASEI Corp.). In this way, colloidal silica is concentrated to the silica concentration 11.8 wt % and approximately 460 g of concentrated colloidal silica is obtained. Obtained colloidal silica has a pH of 9.3 at 25° C., and alkali metal concentration is smaller than 1 ppm.

### Example 8

By same method as Example 5, tetraethoxysilane is hydrolyzed and an active silicic acid aqueous solution having SiO₂ concentration of 3.7 wt % and a pH of 2.5 is obtained. The pH is adjusted to 8.6 by adding 21 g of a 10% arginine aqueous solution to 250 g of the active silicic acid aqueous solution with stirring. After that, solutions are heated with stirring, maintained at 100° C. for 1 hour to form colloid particles. Then, while maintaining the temperature at 100° C., 1400 g of the active silicic acid aqueous solution and 400 g of a 2.7 wt % arginine aqueous solution are simultaneously added by 4 hours to grow silica particles. The 2.7 wt % arginine aqueous solution is prepared by diluting a 10 wt % arginine aqueous solution. After adding process, the solution is matured by maintaining the temperature at 100° C. for 1 hour, then cooled down.

The pH of obtained colloidal silica is 9.8 at 25° C. According to a transmission electron microscope (TEM) observation, obtained colloidal silica is composed of colloidal particles forming irregularly connected nonspherical particles cluster characterized that short axis length of about 18 nm, long axis/short axis ratio of 1.2 to 7, and average long axis/short axis ratio of 3. Particle size calculated from BET method specific surface area is 11 nm.

### Example 9

Colloidal silica obtained by Example 8 is concentrated. Pressure filtration by pump circulation is carried out using hollow fiber ultra-filter membrane whose molecular cutoff value is 6000 (MICROZA UF MODULE SIP-1013, product of ASAHI KASEI Corp.). In this way, the colloidal silica is concentrated to SiO₂ concentration of 8.3 wt %, and approximately 510 g of concentrated colloidal silica is obtained. Obtained colloidal silica has a pH of 9.6 at 25° C., and alkali metal concentration is smaller than 1 ppm.

What is claim:

1. A colloidal silica for semiconductor wafer polishing comprising, colloidal silica prepared from an active silicic acid aqueous solution obtained by hydrolysis of tetraalkoxysilane and at least one nitrogen containing basic compound selected from a group consisting of ethylenediamine, diethylenediamine, imidazole, methylimidazole, piperidine, morpholine, arginine and hydrazine, wherein said colloidal silica contains nonspherical silica particles and pH of the colloidal silica is of 8.5 to 11.0 at 25° C.

2. The colloidal silica for semiconductor wafer polishing of claim 1 further comprising, tetramethylammonium hydroxide, tetraethyl ammonium hydroxide or choline hydroxide.

3. The colloidal silica for semiconductor wafer polishing of claim 1 further comprising, a buffer solution composed of mixing basic nitrogen compounds and strong acid or of mixing weak acid and quaternary ammonium hydroxide, wherein said colloidal silica for semiconductor wafer polishing displays pH buffering action in the pH range of 8.5 to 11.0 at 25° C.

4. The colloidal silica for semiconductor wafer polishing of claim 2 further comprising, a buffer solution composed of mixing basic nitrogen compounds and strong acid or of mixing weak acid and quaternary ammonium hydroxide, wherein said colloidal silica for semiconductor wafer polishing displays pH buffering action in the pH range of 8.5 to 11.0 at 25° C.

5. The colloidal silica for semiconductor wafer polishing of claim 1, wherein said tetraalkoxysilane is tetramethoxysilane or tetraethoxysilane.

6. The colloidal silica for semiconductor wafer polishing of claim 1, wherein average short axis length of said silica particles is of 5 to 30 nm, long axis/short axis ratio is of 1.2 to 20, and average long axis/short axis ratio is of 3 to 15.

7. The colloidal silica for semiconductor wafer polishing of claim 1, wherein said colloidal silica is an aqueous solution whose concentration of silica to entire colloidal silica solution is of 2 to 50 wt %.

8. The colloidal silica for semiconductor wafer polishing of claim 1, wherein said colloidal silica is an aqueous solution whose concentration of alkali metal to entire colloidal silica solution is less than 1 ppm.

9. A production method of colloidal silica for semiconductor wafer polishing of claim 1 comprising:
(a) a producing process of an active silicic acid aqueous solution by hydrolysis of tetraalkoxysilane with acid catalyst in a composition of 1 to 8 mol/L silica, 0.0018 to 0.18 mol/L acid, and 2 to 30 mol/L water without using solvent, then diluting with water so as to adjust the silica concentration within range of 0.2 to 1.5 mol/L; and
(b-1) a formation process of colloidal particles by heating said active silicic acid aqueous solution after alkalizing the solution by adding said basic nitrogen compounds; and
(b-2) a growing process of colloidal particles by adding said active silicic acid aqueous solution and an alkalizing agent or said active silicic acid aqueous solution, said basic nitrogen compounds, and the alkalizing agent to colloidal particles formed in the process (b-1) while maintaining in alkaline condition under heating condition.

10. The production method of colloidal silica for semiconductor wafer polishing of claim 9 further comprising,
(c) a concentration process of the colloidal silica after the process (b-2).
